(19) United States
(12) Patent Application Publication
(10) Pub. No.: US 2021/0382498 A1
(43) Pub. Date: Dec. 9, 2021

(54) MOBILITY ASSIST APPARATUS AND METHOD

(71) Applicant: Thomas Philip Ramstack, Washington, DC (US)

(72) Inventor: Thomas Philip Ramstack, Washington, DC (US)

(21) Appl. No.: 17/303,550

(22) Filed: Jun. 2, 2021

Related U.S. Application Data
(60) Provisional application No. 62/705,047, filed on Jun. 9, 2020.

(51) Int. Cl. G05D 1/02; A61G 5/04; G05D 1/00; G05D 1/08; A61G 5/10

(52) U.S. Cl. CPC G05D 1/0261; A61G 5/04; G05D 1/0255; G05D 1/0038; G05D 1/0891; A61G 2203/726; G05D 2201/0206; A61G 2203/16; A61G 2203/22; A61G 2203/42; A61G 5/1051

(57) ABSTRACT

A system, method, and apparatus to provide mobility assistance to disabled persons. The invention includes a self-driving electric cart for transporting a blind or other disabled person along a pre-defined route defined by a path of magnetic markers. The magnetic markers interact through radio waves with a control mechanism on the cart. Utilizing the present invention, the blind person could touch a button on a pre-programmed control screen and ride safely in self-driving carts to any of several specific destinations, such as a job site, grocery store, relative's home, etc.

### CROSS-REFERENCE TO RELATED APPLICATION

This application claims the benefit of priority of U.S. provisional application No. 62/705,047 filed Jun. 9, 2020, the contents of which are herein incorporated by reference.

### BACKGROUND OF THE INVENTION

The present invention relates to mobility assist devices, and more particularly to motorized electronic carts for transporting disabled persons.

Self-driving vehicles for blind persons are generally limited to roadways, where they can interact with global positioning satellites. However, the blind or disabled persons rarely can get licenses to operate the vehicles on roadways.

Mobility for blind persons may be limited to the use of sidewalks where the person may be guided by a service dog or by using their own cane because global positioning satellites could not direct them safely to their destinations.

As can be seen, there is a need for improved systems, methods, and apparatus for providing mobility assistance to disabled persons.

### SUMMARY OF THE INVENTION

In one aspect of the present invention, a mobility assist device is disclosed. The mobility assist device includes a ground transport vehicle having a plurality of ground transport wheels, a frame, and a seat for supporting at least one occupant. A motor is provided for driving at least one ground transport wheel. A plurality of sensors are configured for detecting an operational state and a position of the ground transport vehicle. The plurality of sensors include a geomagnetic sensor configured to detect a magnetic marker. A processor is configured to receive a signal from each of the plurality of sensors and the geomagnetic sensor to control the ground transport vehicle along a travel path defined by a plurality of magnetic markers.

In some embodiments, the mobility assist device includes a yaw sensor configured to detect a rotational movement of the ground transport vehicle about a vertical axis. The processor is configured to limit a yawing movement of the ground transport vehicle.

In some embodiments, the plurality of sensors includes an ultrasonic sensor oriented towards a front and a rear of the ground transport vehicle. The processor is configured to provide an alert when the ultrasonic sensor detects an obstacle in the travel path.

In some embodiments, a camera system is provided that includes at least one camera oriented in a direction of travel along the travel path. A radio communicates an image from the camera system to a remote-control station.

In some embodiments, a contact sensor is disposed on at least one of a front and a back of the ground transport vehicle. The contact sensor is configured to stop a movement of the ground transport vehicle when a contact is detected.

In some embodiments, a G sensor is provided, and the processor is configured to limit an acceleration and a deceleration of the ground transport vehicle based on a signal from the G sensor.

In some embodiments, a wheel speed sensor is provided. The processor is configured to determine a travel distance along the travel path between a first magnetic marker and a second magnetic marker.

In some embodiments, a touch screen control panel is provided. The at least one occupant can input a command for operation of the ground transport vehicle via the touch screen control panel. The touch screen control panel may include a plurality of haptic feedback controls.

In yet other embodiments, the motor is an electric motor.

These and other features, aspects and advantages of the present invention will become better understood with reference to the following drawings, description and claims.

### BRIEF DESCRIPTION OF THE DRAWINGS

FIG. 1 is a block diagram of the mobility assist apparatus;

FIG. 2 is a schematic diagram showing the mobility assist apparatus negotiating a path;

FIG. 3 is a graph showing a magnetic force v. travel distance in each of an X, a y, and a z axis;

FIG. 4A is a first part of a flowchart showing a method of operating the mobility assist apparatus;

FIG. 4B is a second part continuation of the flowchart of FIG. 4A;

FIG. 4C is a third part continuation of the flowcharts of FIGS. 4A and 4B;

FIG. 5A is a series of three graphs showing a magnetic path guidance of the mobility assist apparatus;

FIG. 5B is a table;

FIG. 6 is another flowchart depicting a course navigation algorithm; and

FIG. 7 is a block diagram of the invention showing communications with the an autonomous wheelchair/bed (AWCB) system processor.

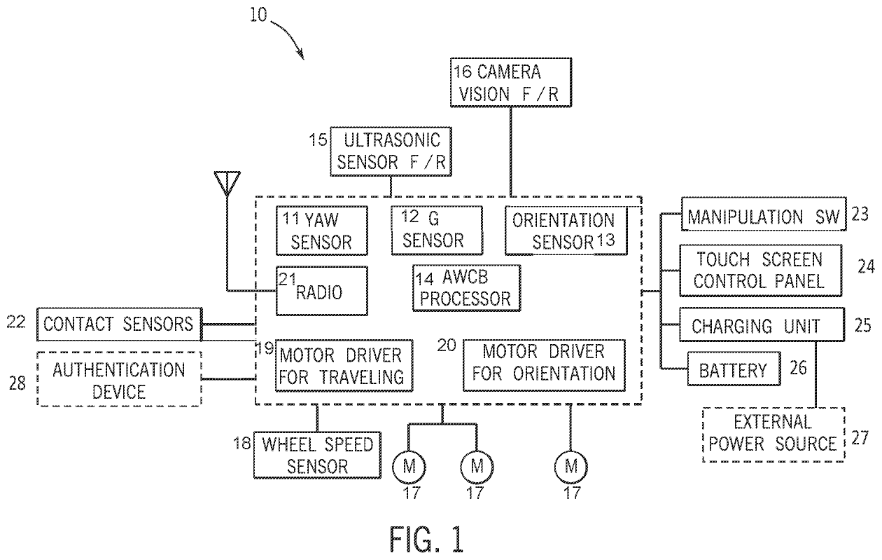

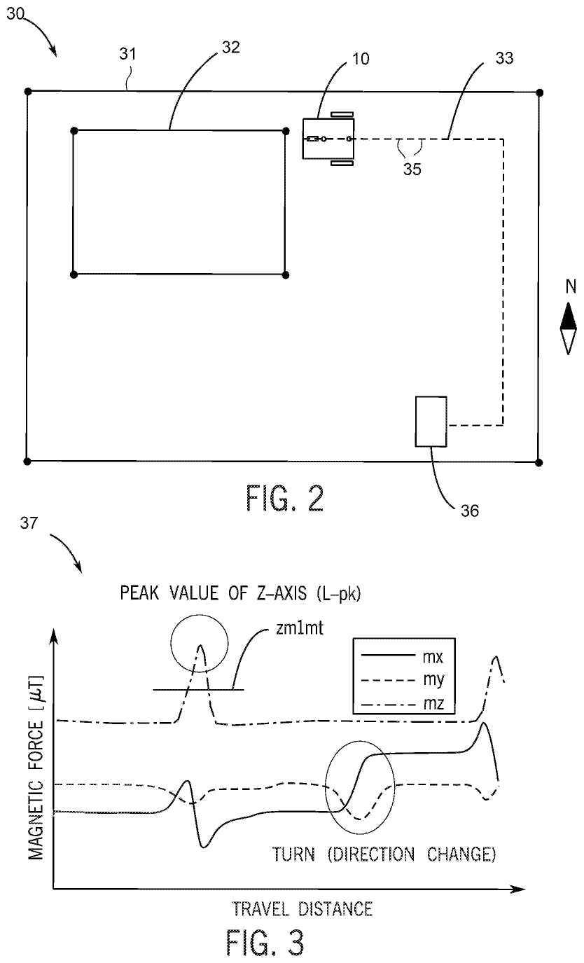

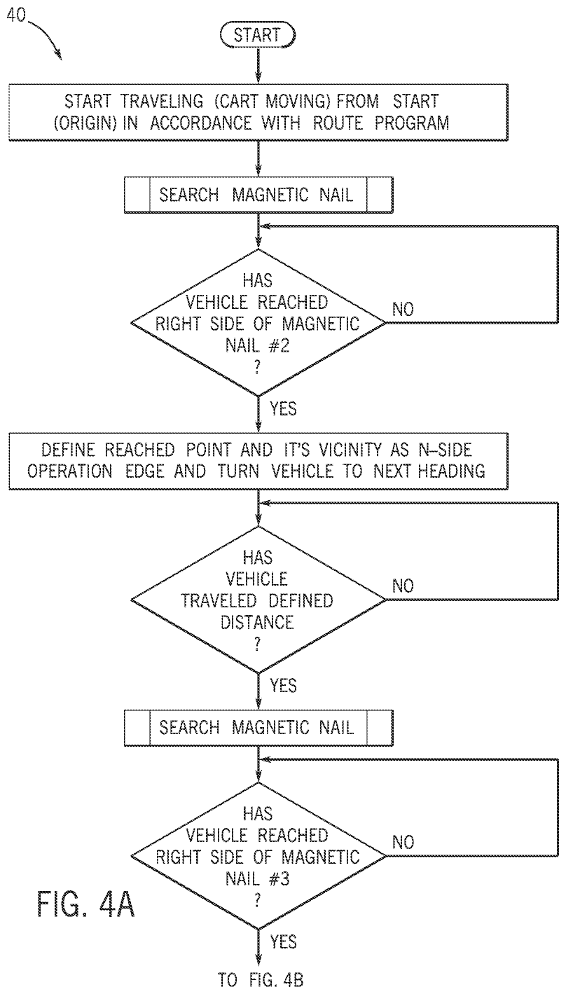

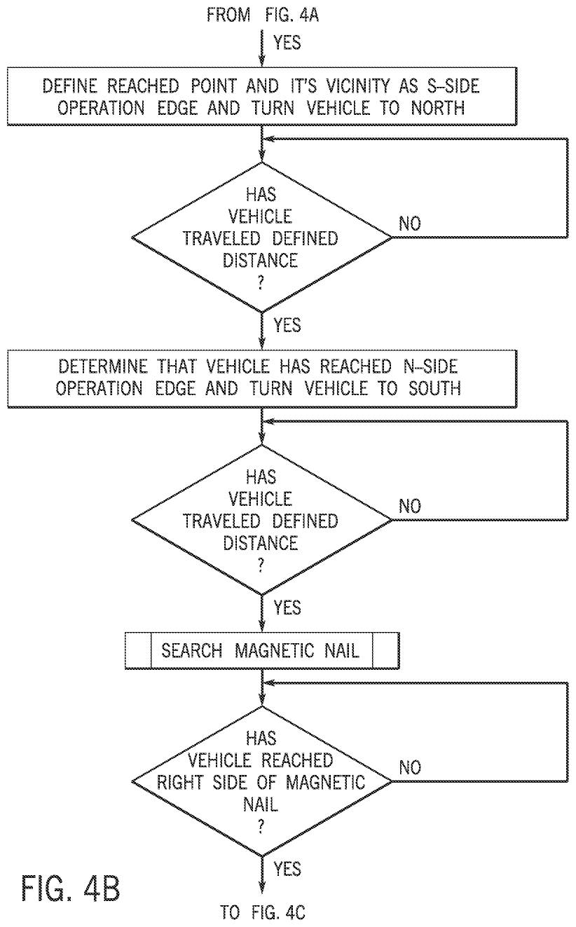

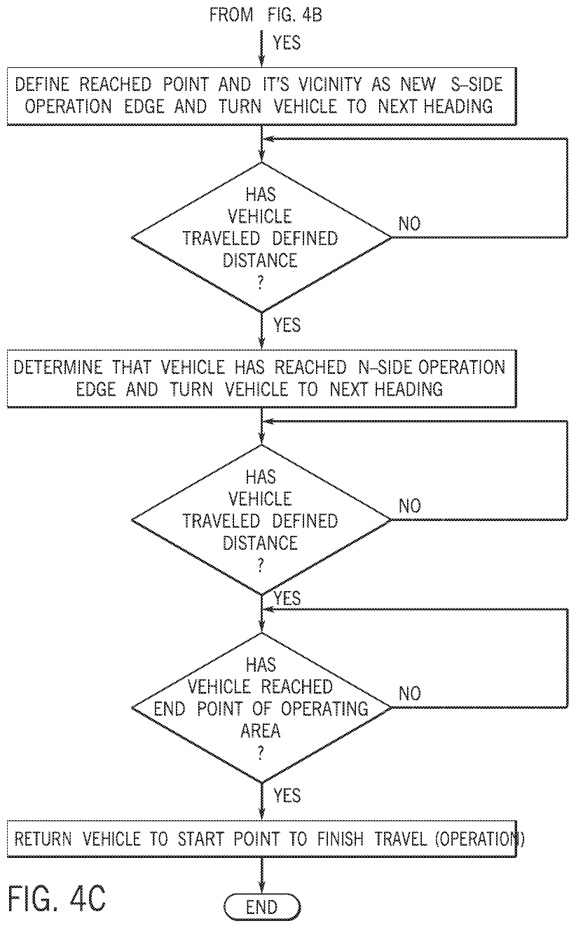

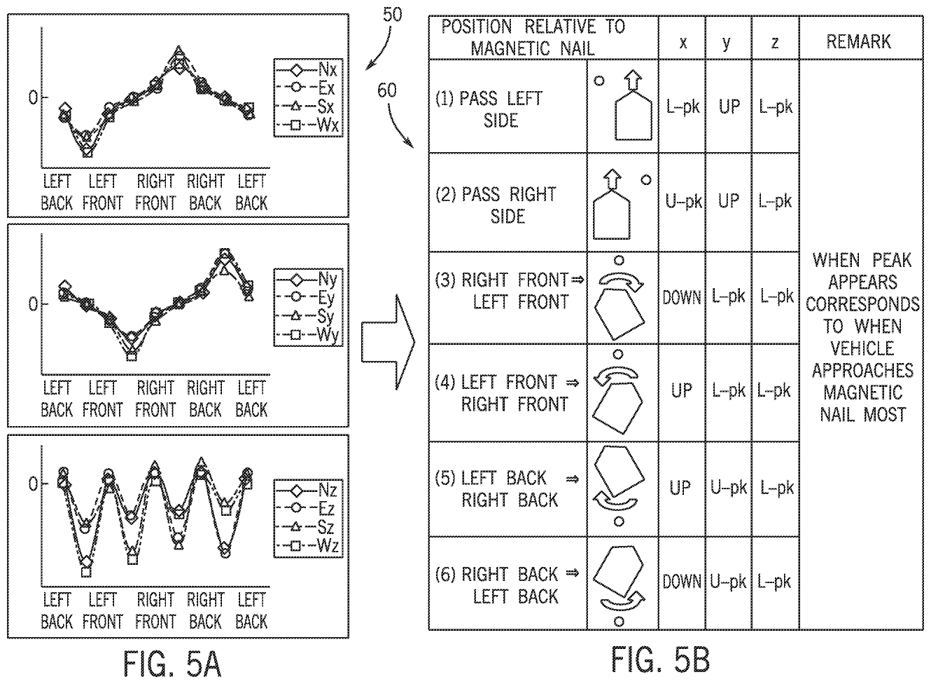

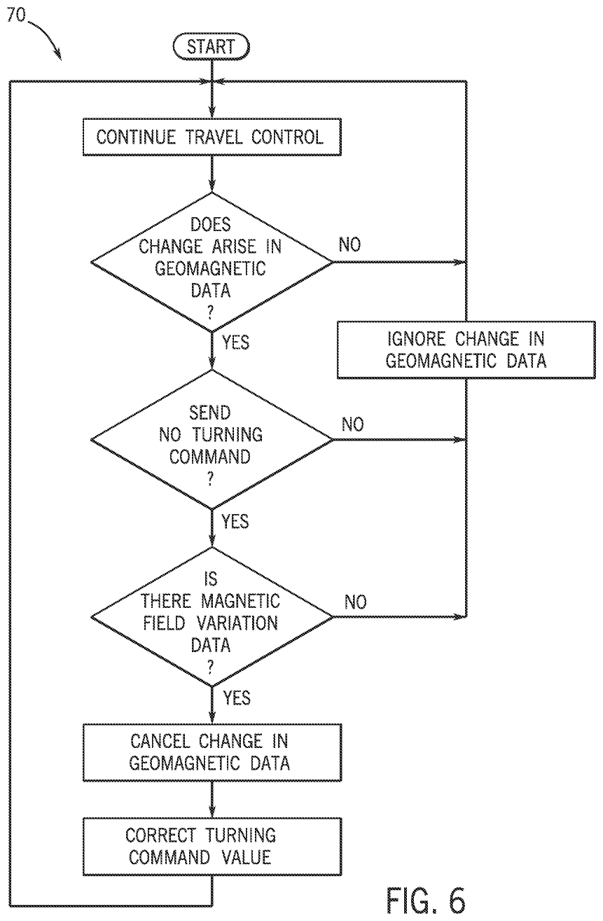

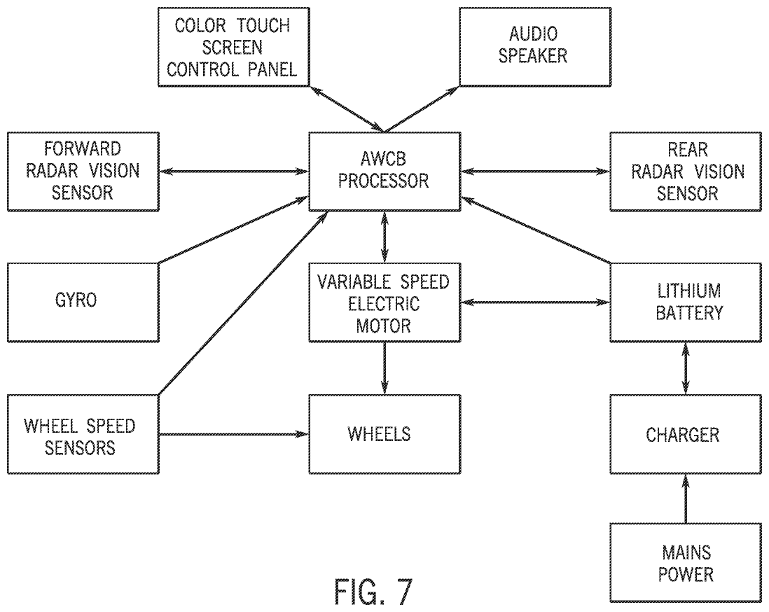

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a system method and apparatus that permits blind persons to ride safely in a self-driving carts to or about any of several destinations, such as a job site, a grocery store, a relative's home, etc.

Aspects of the present invention would employ use of self-driving carts powered by rechargeable batteries to carry disabled persons along a sidewalk or other courses toward a destination they choose. The cart would direct themselves along the appropriate path by deriving digital location information from magnetic markers 16 implanted in the ground and interpreting it with an onboard encoder.

As seen in reference to the drawings, components of the present invention may include the following elements:
10 is an automated wheelchair/vehicle for disabled persons;
11 is a yaw sensor;
12 is a G sensor;
13 is a geomagnetic orientation sensor;
14 is an autonomous wheelchair/bed (AWCB) processor;
15 is an ultrasonic sensor (front and/or rear);
16 is a camera vision system (front and/or rear);
17 is a motor;
18 is a wheel speed sensor;
19 is a motor driver, for controlling the traveling motors 17;
20 is a motor driver for the orientation motor;
21 is a radio;
22 are contact sensors;
23 is a manipulation switch;
24 is a touch screen control panel;
25 is a charging unit;
26 is a battery;
27 is an external power source;
28 an authentication device;
30 depicts an operating area of the automated vehicle 10;
31 depicts a boundary of the operating area;
32 is a restricted area;
33 is a designated travel route;
35 are the magnetic markers, designating the travel route;
36 is one of a start point or a destination along the designated travel route;
37 a detection of the magnetic markers during a traversal of a route;
40 is the flowchart depicting a navigation system for the vehicle 10;
50 are the vehicle tracking charts;
60 is the vehicle orientation system;
70 is the second flowchart; and
80 is an autonomous wheelchair/bed (AWCB) system

In one aspect of the invention, a mobility system for assisting blind and low-vision persons to move around independently is disclosed. The system provides a self-driving automated scooter/or vehicle 10 that operates with an automated pathway detection device as a driving control that detects successive magnetic fluxes from ceramic magnetic markers 35 embedded in a pathway, such as a sidewalks, an intersection crossings, and other rights-of-way at a predetermined interval.

The system comprises a magnetic sensor 13 for detecting the magnetic fluxes caused by the magnetic markers 35. An audible or a tactile alarm 20 may be provided for alerting the occupants of deviations from the predetermined path set by the magnetic markers 35. A propulsion system for propelling the scooter 10 includes one or more traveling motors 17 and orientation motor 17, that through the various sensors enable the self-driving scooter vehicle 10 along the path 33 set by the magnetic markers 35. Audible signals may alert the occupants to their location along the predetermined path 33.

In some embodiments, a real-time video camera vision system 16 with an Internet link to a human viewer and dispatch center may be provided. The scooter 10 may be equipped with an automated braking system linked to a forward-and-rear-facing radar or ultrasonic sensor system 15 to stop the scooter 10 before hitting an obstacle. The alarm 20 may also be configured to alert the operator to the location of the scooter/vehicle 10 along the path. A horn may be linked to motion sensors 15 to warn human passersby of the approaching scooter 10. Additionally, the operators would be able to detect the location of their scooter/vehicle 10 when they are separated from them using a car alarm beeper adapted to the scooter/vehicles 10 through an authentication system 28.

An apparatus for controlling an automated scooter/vehicle 10 having operating equipment configured with a geomagnetic sensor 13 incorporated with the scooter/vehicle 10 that is responsive to the magnetic markers 35 embedded in a surface to define a pathway that can direct the scooter 10 operator by audible cues within a travel-scheduled area. As seen in FIG. The geomagnetic sensor 13 is configured to assess x-axis), y-axis, and z-axis outputs, mounted on a scooter 10 and responsive to the magnetic markers 16 embedded in the travel-scheduled area. An angular velocity sensor may be adapted to detect an angular velocity generated about z-axis that goes through a geomagnetic sensor on the scooter 1 and is perpendicular to a travel direction of the scooter 1.

A wheel speed sensor 18 is adapted to monitor the directional movement of the scooter 10 when coupled with the geomagnetic sensor 13. A map information storage component may be programmed and adapted to define the travel-scheduled area and store map information, including an embedded position of the magnet markers 35 indicated with an x-y coordinate position.

Each of the elements may be utilized according to the following descriptions:

(1) The scooter/vehicle 10 is the device that transports riders;

(2) The ultrasonic sensor 15 monitors forward and reverse directions at least during movement of the scooter 10;

(3) The contact sensor 22 provides signal alerts to the controlling mechanism as magnetic sensors 13 on the scooter 10 pass over magnet markers 35 embedded in the travel-scheduled area 33;

(4) The yaw sensor 11 detects twisting or oscillation of the scooter/vehicle 10 around a vertical axis, so as to limit yawing motions that may throw the rider from the scooter 10;

(5) The G-sensor 12 detects changes in acceleration to properly control speed of the scooter/vehicle 10, and may also limit accelerations that may throw the rider from the scooter 10;

(6) The geomagnetic orientation sensor 13 detects the angle of movement of the scooter-vehicle 10 to keep it traveling along the travel-scheduled area 33 as directed by its operator;

(7) The manipulation switch 237 allows the operator's pre-programmed instructions to direct the scooter/vehicle 10 appropriately on the selected pathway 33;

(8) The authentication device 28 allows the scooter/vehicle 10 to verify that the pre-programmed travel instructions come from an authorized operator;

(9) The radio 21 allows the scooter/vehicle's systems that transmit and receive bandwidth signals to communicate with each other. A separate part of the radio 21 allows the operator to communicate with other persons who have receivers and transmitters that operate on the same bandwidth of the radio spectrum as the scooter/vehicle's transmitter and receiver;

(10) The display 24 may be a tactile or a haptic display that allows the operator to program a travel-scheduled route 33 and to monitor performance of the scooter/vehicle 10;

(11) the motor driver 19 for traveling propels the scooter/vehicle 10;

(12) The motor driver 12 for operation keeps the on-board equipment working properly;

(13) The charging unit 13 provides an electrical power to charge the battery 14 for the scooter/vehicle 1;

(14) The battery 26 is the source of electrical energy for powering the scooter/vehicle 10;

(15) The wheel speed sensor 18 monitors the speed of the scooter/vehicle 10;

(16) The magnetic markers 35 allow the scooter/vehicle 10 to be guided along the travel-scheduled area 33;

(17) The area signal generator 17 provides the radio signals that can be detected by on-board sensors;

18) The operating area wire 31 designates a digital map that sets the parameters of the scooter/vehicle's 10 operating area;

(19) a geomagnetic flux sensor 13 detects the magnetic markers 35 that guide the scooter vehicle 10 on a selected pathway 33;

(20) an alarm 21 alerts the operator to provide guidance instructions and warn of hazards along the pathway; and

(21) an electronic control unit (AWCB Processor) 14 controls the collection of on-board controls and sensors for the scooter/vehicle 10.

An absolute direction and position detector may be adapted to detect an absolute direction based on the output of the geomagnetic sensor 13, detect an approach direction to the magnetic marker 35 by comparing the output of the geomagnetic sensor 13 with a pre-stored output pattern. The system detects a position of the geomagnetic sensor 35 in the travel-scheduled area based on the detected approach direction and the map information. A direction and distance calculator is adapted to calculate a traveling direction based on the output of the angular velocity sensor 11 and a traveled distance based on the output of the geomagnetic sensor 13, and wheel speed sensor 18. An operation controller 14 is adapted to control the operation performed through the operating machine in the travel-scheduled area in accordance with a preset operation program based on the detected absolute direction. The detected position of the geomagnetic sensor 35 within the travel-scheduled area, the calculated traveling direction and the calculated traveled distance.

The present invention would partially resolve the problem of limited mobility encountered by many blind, paralyzed or other disabled persons. Currently, blind persons must be guided by service dogs, other persons or through their own limited efforts to walk with canes. This invention could vastly increase their range of movement to specific destinations with only minimal dependence on other persons or service animals. They could touch buttons on a display screen 24 that include tactile or auditory cues and then ride in their scooter/vehicle 10 to destinations pre-programmed into their travel-scheduled area 30. The present invention could also be used to carry products to destinations pre-programmed into a travel-scheduled area 30, even if human operators are not on board.

It should be understood, of course, that the foregoing relates to exemplary embodiments of the invention and that modifications may be made without departing from the spirit and scope of the invention as set forth herein.

What is claimed is:

1. A mobility assist device, comprising:
a ground transport vehicle having a plurality of ground transport wheels, a frame, and a seat for supporting at least one occupant;
a motor for driving at least one ground transport wheel;
a plurality of sensors configured for detecting an operational state and a position of the ground transport vehicle, the plurality of sensors comprising a geomagnetic sensor configured to detect a magnetic marker; and
a processor configured to receive a signal from each of the plurality of sensors and the geomagnetic sensor to control the ground transport vehicle along a travel path defined by a plurality of magnetic markers.

2. The mobility assist device of claim 1, wherein the plurality of sensors further comprise:
a yaw sensor configured to detect a rotational movement of the ground transport vehicle about a vertical axis; and
the processor is configured to limit a yawing movement of the ground transport vehicle.

3. The mobility assist device of claim 2, wherein the plurality of sensors further comprise:
an ultrasonic sensor oriented towards a front and a rear of the ground transport vehicle, and
the processor is configured to provide an alert when the ultrasonic sensor detects an obstacle in the travel path.

4. The mobility assist device of claim 3, wherein the plurality of sensors further comprise:
a camera system, including at least one camera oriented in a direction of travel along the travel path;
a radio communicating an image from the camera system to a remote-control station.

5. The mobility assist device of claim 4, wherein the plurality of sensors further comprise:
a contact sensor disposed on at least one of a front and a back of the ground transport vehicle, the contact sensor configured to stop a movement of the ground transport vehicle when a contact is detected.

6. The mobility assist device of claim 5, wherein the plurality of sensors further comprise:
a G sensor, and
the processor is configured to limit an acceleration and a deceleration of the ground transport vehicle.

7. The mobility assist device of claim 6, wherein the plurality of sensors further comprise:
a wheel speed sensor; and
the processor is configured to determine a travel distance along the travel path between a first magnetic marker and a second magnetic marker.

8. The mobility assist device of claim 1, further comprising:
a touch screen control panel, in communication with the processor, wherein the at least one occupant can input a command for operation of the ground transport vehicle.

9. The mobility assist device of claim 8, wherein the touch screen control panel has a plurality of haptic feedback controls.

10. The mobility assist device of claim 1, wherein the motor is an electric motor.
